(19) United States
(12) Patent Application Publication
(10) Pub. No.: US 2008/0079398 A1
(43) Pub. Date: Apr. 3, 2008

(54) Chargeable Inverter Power Supply

(76) Inventor: Wei-guang Li, Guangdong (CN)

Correspondence Address: MERCHANT & GOULD PC, P.O. BOX 2903, MINNEAPOLIS, MN, 55402-0903, US

(21) Appl. No.: 11/664,200

(22) PCT Filed: Jul. 22, 2005
(86) PCT No.: PCT/CN05/01099

§ 371 Date: Mar. 29, 2007

(51) Int. Cl. H02J 7/00

(52) U.S. Cl. 320/140

(57) ABSTRACT

A chargeable inverter power supply includes an inverter, a microcontroller unit (MCU) (1), a DC/DC converting circuit (9), and a charger electrically connected with the inverter. The charger includes two NI-MH, NI-CD battery charging circuits (10,11) and two battery voltage detecting circuits (12,13). Each component of the inverted power supply is controlled by the MCU. Voltages for the MCU and the NI-MH, NI-CD battery charging circuits are provided by the DC/DC converting circuit. The MCU is connected to a voltage detecting circuit (4), a power detecting circuit (6) and a temperature detecting circuit (8). In addition to act as an inverter power supply, the chargeable inverter power supply can also be used to charge NI-MH, NI-CD batteries (B1, B2).

### BACKGROUND OF THE INVENTION

1. Field of the Invention

The present invention generally relates to a chargeable inverter power supply.

2. Description of Related Art

Generally, a conventional inverter power supply does not include NI-MH, NI-CD battery charging circuits and, therefore, cannot be used to charge NI-MH, NI-CD batteries. When the NI-MH, NI-CD batteries need to be charged, the inverter power supply must be connected to an exterior charger, which may potentially increase the cost. An example of the inverter power supplies is typically disclosed in Chinese application No. 98100504.7, filed on Feb. 10, 1998 and titled “Inverter Power Supply Having Magnetic Amplifier”. The inverter power supply includes a direct current power source, an inverter, a voltage converting device, an AC/DC (alternating current/direct current) converting device and a control device. The inverter is connected between the direct current power source and the voltage converting device. The voltage converting device is connected between the inverter and the AC/DC converting device. A current transmission device is connected between the AC/DC converting device and a load.

The inverter converts a direct current output from the direct current power source into a high frequency alternating current. The AC/DC converting device converts the high frequency alternating current into direct current. The current transmission device outputs the direct current from the AC/DC converting device to the load. The voltage converting device has a magnetic amplifier and a transformer. The magnetic amplifier is connected between a primary winding of the transformer and the inverter. The control device controls an output power of the inverter power supply, and is connected with the inverter. The control device can generate a control signal having variable frequency, so as to control switch frequency of the inverter. Output power of the inverter power supply is controlled by the switch frequency of the inverter and is in inverse ratio to the switch frequency of the inverter.

However, the inverter power supply as described previously does not include NI-MH, NI-CD battery charging circuits and, therefore, can not be used to charge a NI-MH, NI-CD battery if the inverter power supply does not be connected to an exterior charger.

What is needed, therefore, is to provide a chargeable inverter power supply which can be used to charge NI-MH, NI-CD batteries.

### SUMMARY OF THE INVENTION

According to one embodiment of the present invention, a chargeable inverter power supply includes an inverter, an one piece microcontroller unit (MCU), a DC/DC converting circuit, and a charger electrically connected with the inverter. The charger includes at least one NI-MH, NI-CD battery charging circuit and at least one battery voltage detecting circuit. Each components of the chargeable inverted power supply are controlled by the same MCU. Voltages of the MCU and the NI-MH, NI-CD battery charging circuit are provided by the DC/DC converting circuit. A voltage detecting circuit, a power detecting circuit, and a temperature detecting circuit are also connected to the MCU. The chargeable inverter power supply in accordance with the embodiment of the present invention has following advantages. Because the chargeable inverter power supply includes NI-MH, NI-CD battery charging circuits, it can be widely used to charge nickel-metal (NI-MH) or nickel-cadmium (NI-CD) batteries. Additionally, the inverter and the NI-MH, NI-CD battery charging circuits are controlled by a same MCU. Voltages of the MCU and the NI-MH, NI-CD battery charging circuit are both provided by a DC/DC converting circuit. Therefore, the chargeable inverter power supply has simple structure and can be used safely.

Other advantages and novel features will be drawn from following detailed description of preferred embodiment with the attached drawings, in which:

### BRIEF DESCRIPTION OF THE DRAWINGS

FIG. 1 is a block diagram of a chargeable inverter power supply in accordance with a preferred embodiment of the present invention; and

FIG. 2 is a circuit diagram of the chargeable inverter power supply according to the preferred embodiment of the present invention.

### DETAILED DESCRIPTION OF THE INVENTION

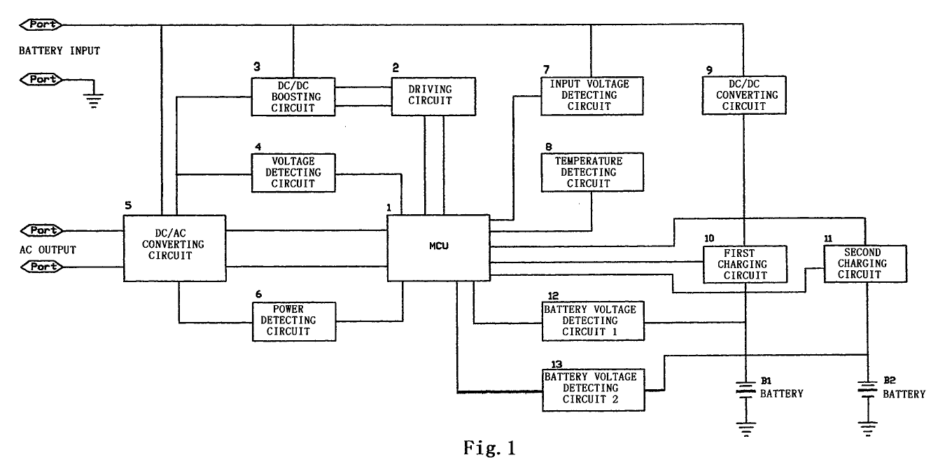

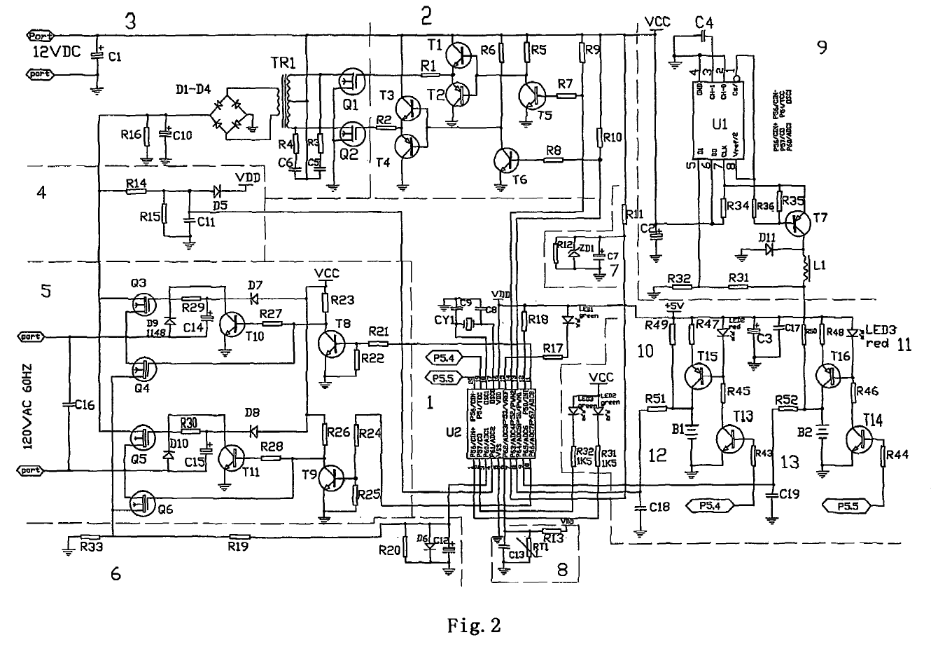

Referring to FIG. 1 and FIG. 2, the chargeable inverter power supply according to one embodiment of the present invention includes an inverter, a microcontroller unit (MCU), a DC/DC converting circuit, and a charger electrically connected to the inverter. The charger includes two NI-MH, NI-CD battery charging circuits and two battery voltage detecting circuits. Alternatively, the charger can include one or more NI-MH, NI-CD battery charging circuits and one or more battery voltage detecting circuits. The charger is provided to charge a chargeable nickel-metal (NI-MH) or a nickel-cadmium (NI-CD) battery. Each component as previously described is controlled by a same MCU. Voltages for the MCU and the NI-MH, NI-CD battery charging circuits are provided by the DC/DC converting circuit. The MCU is further connected with a voltage detecting circuit, a power detecting circuit, and a temperature detecting circuit.

FIG. 1 is a block diagram of the chargeable inverter power supply according to a preferred embodiment of the present invention. The chargeable inverter power supply includes a MCU 1, a driving circuit 2, a DC/DC boosting circuit 3, a voltage detecting circuit 4, a DC/AC converting circuit 5, a power detecting circuit 6, an input voltage detecting circuit 7, a temperature detecting circuit 8, a DC/DC converting circuit 9, a first NI-MH, NI-CD battery charging circuit 10, a second NI-MH, NI-CD battery charging circuit 11, a first battery voltage detecting circuit 12, and a second battery voltage detecting circuit 13. The MCU 1 is directly or indirectly connected with the previously described circuits.

FIG. 2 illustrates a circuit diagram of the chargeable inverter power supply. A main control circuit includes a MCU U2, a crystal CY1, capacitors C8 and C9. Under the control of the interior programs of the MCU U2, the MCU U2 outputs a high-frequency Pulse-Width Modulation (PWM) signal via pin 14 thereof to a triode T5, and outputs another high-frequency PWM signal via pin 13 thereof to triode T6. The high-frequency PWM signals are respectively inverted by triodes T5 and T6, and successively delivered via a driving circuit consisted of triodes TI, T2, T3, and T4, control field effect transistors Q1, Q2 to alternately conduct and pinch-off, so as to obtain a high-frequency alternating current voltage in the secondary winding of switch transformer TR1. The high-frequency alternating current voltage is bridge rectified by fast recovery diodes D1-D4 and filtered by an electrolytic capacitor C10, thereby generating a direct current high voltage. The amount of the voltage is equal to an amplitude value of an output alternating current.

The MCU U2 outputs a low-frequency PWM signal via pin 10 thereof to a triode T9, and outputs another low-frequency PWM signal via pin 11 thereof to a triode T8. The low-frequency PWM signals are respectively inverted and voltage-converted by triodes T8 and T9, and then push full-bridge converter circuit to alternately conduct and pinch-off, whereby the direct current high-voltage is converted into a power frequency alternating current output. The full-bridge converter circuit is consisted of field effect transistors Q3, Q4, Q5, and Q6.

The direct current high-voltage is delivered to pin 4 of the MCU U2 after being divided by resistors R14 and R15. The MCU U2 converts the direct current high-voltage from an analog value to a digital value. The MCU U2 controls duty ratio of the low frequency PWM signals via control the programs therein, so as to adjust the alternative current voltage output.

The power detecting circuit 6 includes resistors R33, R19, R20, a diode D6, and a filter capacitor C12. The power detecting circuit samples a power value and outputs the power value to pin 3 of the MCU U2. The MCU U2 converts the power value from an analog value to a digital value, and determines a power output. When the power output is greater than the biggest power of the product, the MCU U2 stops outputting the high frequency PWM signals and, therefore, stopping outputting the alternating current.

The temperature detecting circuit includes a resistor R13, a resistor having inherent variability dependent RT1, and a capacitor C13. The temperature detecting circuit samples a temperature signal and transmits the temperature signal to pin 6 of the MCU U2. The MCU U2 converts the temperature signal from an analog value to a digital value, and determines interior temperature of the product. If the temperature is too high, the MCU U2 stops outputting the high-frequency PWM signals and, thus, stop outputting the alternating current.

The input voltage detecting circuit 7 includes resistors R11, R12, a zener diode ZD1, and a capacitor C7. The input voltage detecting circuit 7 samples an input voltage and transmits the input voltage to pin 7 of the MCU U2. The MCU U2 converts the input voltage from an analog value to a digital value. If the input voltage is too high or too low relative to a predetermined amount, the MCU U2 controls the product to stop working.

The DC/DC converting circuit 9 includes an IC U1 and exterior circuits. The DC/DC converting circuit 9 converts an input voltage from a battery into a 5V direct current voltage, and provides current for the MCU U2, the first NI-MH, NI-CD battery charging circuit 10 and the second NI-MH, NI-CD battery charging circuit 11.

The first NI-MH, NI-CD battery charging circuit 10 includes a resistor R47, a light-emitting diode (LED) LED2, a triode T15, a resistor R49, a resistor R45, a triode T13, and a resistor R43. The NI-MH, NI-CD battery charging circuit 10 is used to fast charge two NI-MH NI-CD batteries. The first battery voltage detecting circuit 12 includes a resistor R51 and a capacitor C18. The first battery voltage detecting circuit 12 detects the voltage of the first NI-MH, NI-CD battery B1, and transmits a voltage detecting signal to pin 8 of the MCU U2. When the MCU U2 detects the first NI-MH, NI-CD battery B1 is chargeable according to the voltage detected signal, the MCU U2 outputs a high voltage for controlling a triode T12 to conduct via a pin 19 thereof, thereby conducting the triode T15. A constant current circuit includes the resistor R47, the triode T15, and the LED 2. The constant current circuit charges for the first NI-MH, NI-CD battery B1. When the MCU U2 detects that the first NI-MH, NI-CD battery B 1 is charged to a peak voltage value, the MCU U2 outputs a low voltage via pin 19 thereof, the triodes T13, T15 are pinched-off, thereby stopping fast charging for the first NI-MH, NI-CD battery B1. The 5V voltage trickle charges the first NI-MH, NI-CD battery B1 via R49.

The second NI-MH, NI-CD battery charging circuit 11 includes a resistor R48, a LED3, a triode T16, a resistor R50, a resistor R46, a triode T14, and a resistor R44. The second battery voltage detecting circuit 13 includes a resistor R52 and a capacitor C19. Principle of the second NI-MH, NI-CD battery charging circuit 11 and the second battery voltage detecting circuit 13 charging for the second NI-MH, NI-CD battery B2, is the same as that of the first NI-MH, NI-CD battery charging circuit 10 and the first battery voltage detecting circuit 12 charging for the first NI-MH, NI-CD battery B1 as described above.

The charger can also include a number of NI-MH, NI-CD battery charging circuits connected together in parallel manner. Each of the battery charging circuits is connected with a corresponding battery voltage detecting circuit.

The chargeable inverter power supply in accordance with the embodiment of the present invention not only can act as an inverter power supply, but also can be used to charge NI-MH, NI-CD batteries Additionally, the chargeable inverter power supply has simple structure and can be used safely.

While the present invention has been illustrated by above description of the preferred embodiment thereof, and while the preferred embodiment has been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and the illustrative examples shown and described.

What is claimed is:

1. A chargeable inverter power supply, comprising:
an inverter;
a microcontroller unit (MCU);
a DC/DC converting circuit; and
a charger comprising NI-MH, NI-CD battery charging circuits electrically connected to the inverter.

2. The chargeable inverter power supply of claim 1, wherein the MCU is one piece, and the inverter and the charger comprising NI-MH, NI-CD battery charging circuits are both controlled by the MCU.

3. The chargeable inverter power supply of claim 1, wherein voltages for the MCU and the NI-MH, NI-CD battery charging circuits are provided by the DC/DC converting circuit.

4. The chargeable inverter power supply of claim 1, wherein the MCU is connected to a voltage detecting circuit, a power detecting circuit and a temperature detecting circuit.

5. The chargeable inverter power supply of claim 1, wherein the NI-MH, NI-CD battery charging circuits of the charger are connected with battery voltage detecting circuits.

6. The chargeable inverter power supply of claim 5, wherein the charger comprises a plurality of NI-MH, NI-CD battery charging circuits connected together in parallel manner, each NI-MH, NI-CD battery charging circuit is connected with a battery voltage detecting circuit.
